(19) United States
(12) Patent Application Publication
(10) Pub. No.: US 2004/0051793 A1
(43) Pub. Date: Mar. 18, 2004

(54) Imaging device

(76) Inventors: Kirk S. Tecu, Greeley, CO (US); William R. Haas, Fort Collins, CO (US); David W. Boll, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/245,958

(22) Filed: Sep. 18, 2002

(51) Int. Cl. H04N 5/76

(52) U.S. Cl. 348/231.99

(57) ABSTRACT

A digital imaging device includes an electronic image sensor for producing a first signal. A processor connected to the electronic image sensor output produces a lower resolution second signal from the first higher resolution signal. The first higher resolution signal is temporarily stored in a memory buffer connected to the electronic image sensor.

### FIELD OF THE INVENTION

This invention relates generally to imaging devices and more specifically to an imaging device which can simultaneously produce high resolution still images or video and low resolution video.

### BACKGROUND

Electronic imaging devices such as digital cameras and video recorders have become extremely widely used as image quality and usability have improved and cost has gone down. Acceptance of digital cameras which capture still images has grown as the resolution and quality of their image sensors and of photographic printers has increased. Relatively inexpensive digital cameras are currently available whose image sensors are charge-coupled devices (CCD's) having millions of picture elements (pixels). Digital video cameras are also gaining acceptance as they gain features such as low-light sensitivity, infrared detection, and digital zoom, with their resolution at least as good as analog consumer video cameras.

However, users are still forced to carry two different digital imaging devices for capturing quality still images and video. Many digital cameras now include a mode for recording short segments of low quality video at a low frame rate with poor sound, and many digital video cameras can capture still images, but at the relatively poor resolution used in video cameras.

These imaging devices which attempt to bridge the gap between digital cameras and video recorders thus perform only one of the two tasks well, either capturing higher resolution still images or lower resolution video. Typically, these imaging devices are based on a CCD which can produce at least two resolutions at the output, one higher than the other, but only one at a time. The CCD generally includes internal circuitry for reducing the resolution at the output from the maximum, and this circuitry can be enabled or disabled to filter the output. Thus, the CCD can either produce the maximum resolution at the output or a reduced resolution, but not both. Because digital cameras and video recorders use CCD's with either a single available resolution or these multi-resolution CCD's with separately selectable resolutions, the digital imaging devices must be configured for one type of imaging. Furthermore, because of these limitations, the digital imaging devices are typically designed to do only one thing well, with badly performing secondary modes.

Users of these digital imaging devices are thus forced to either use two different devices for quality still imaging and video recording, or to use only one device but settle for quality in either still images or video, but not both, and to perform only one type of imaging at a time.

### SUMMARY

An exemplary embodiment of the invention may consist of a digital imaging device having an electronic image sensor for producing a first signal. A processor connected to the electronic image sensor output produces a lower resolution second signal from the first higher resolution signal. The first higher resolution signal is temporarily stored in a memory buffer connected to the electronic image sensor.

Another exemplary embodiment of the invention may consist of a method of capturing images, in which a stream of electronic images is generated, and at least a portion of the stream is stored in a buffer. A second stream of lower resolution electronic images is generated based on the first higher resolution stream.

### BRIEF DESCRIPTION OF THE DRAWING

Illustrative embodiments of the invention are shown in the accompanying drawing, in which:

FIG. 1 is an isometric rear view illustration of an exemplary embodiment of an imaging device;

FIG. 2 is an isometric front view illustration of an exemplary embodiment of an imaging device;

FIG. 3 is a block diagram of an exemplary embodiment of an imaging device;

FIG. 4 is a block diagram of another exemplary embodiment of an imaging device;

FIG. 5 is a block diagram of another exemplary embodiment of an imaging device;

FIG. 6 is a flow chart illustrating an exemplary embodiment of an image capture operation; and

FIG. 7 is a flow chart illustrating another exemplary embodiment of an image capture operation.

### DESCRIPTION

The drawing and description, in general, disclose an imaging device for capturing both high resolution still images (or a sequence of high resolution video) and lower resolution video. An electronic image sensor produces a series or stream of high resolution images, forming high resolution video. Low resolution video is also generated in real-time by downsampling the high resolution video stream. The most recently captured high resolution video is stored in a cyclic buffer, from which high resolution still images or a sequence of high resolution video can be copied while the low resolution video continues. The frame rate of both the high and low resolution streams may be configurable, as well as the resolution of the downsampled video.

Thus, a single digital imaging device provides both high quality high resolution still images and high quality video at the desired lower resolution tailored for output devices such as televisions and computer monitors. This enables a user to capture both video and still images simultaneously without having to manage two different imaging devices at the same time. The still images and video are produced at the same high quality expected from devices dedicated to one or the other imaging format. The result is a simpler imaging process at a lower overall cost.

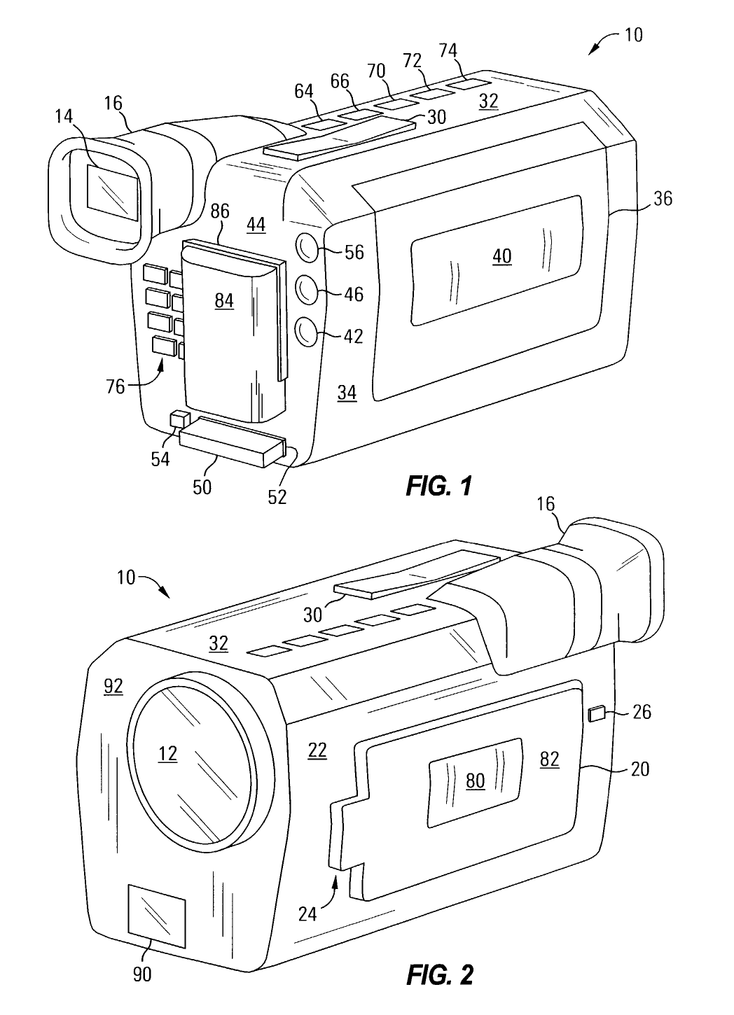

Referring now to FIGS. 1 and 2 simultaneously, an exemplary embodiment of an imaging device 10 for capturing both high resolution still images and lower resolution video will be described. Note that the shape, options and configuration of the imaging device 10 is purely exemplary, and that any suitable alternative configurations are within the scope of the invention.

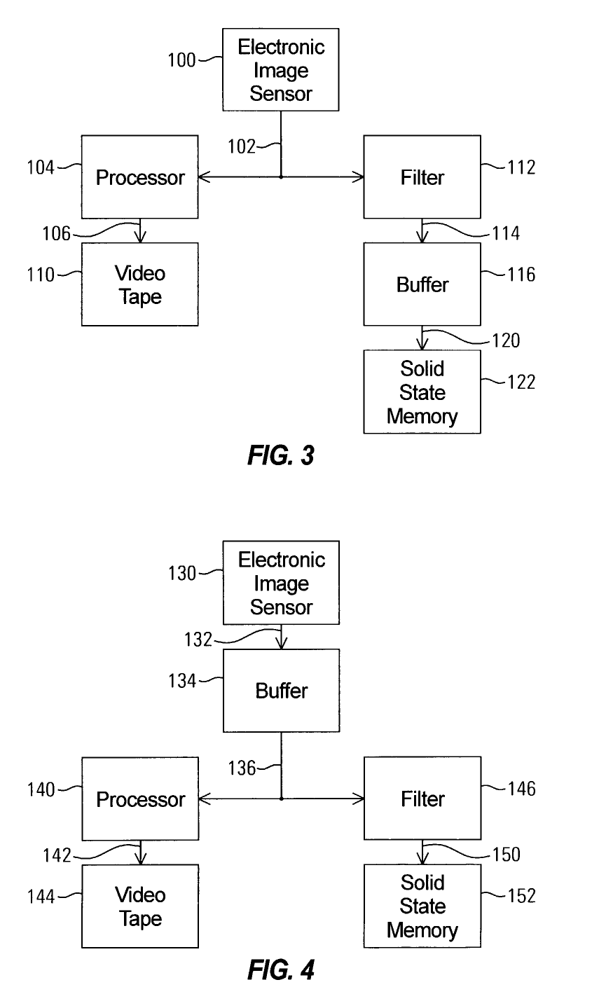

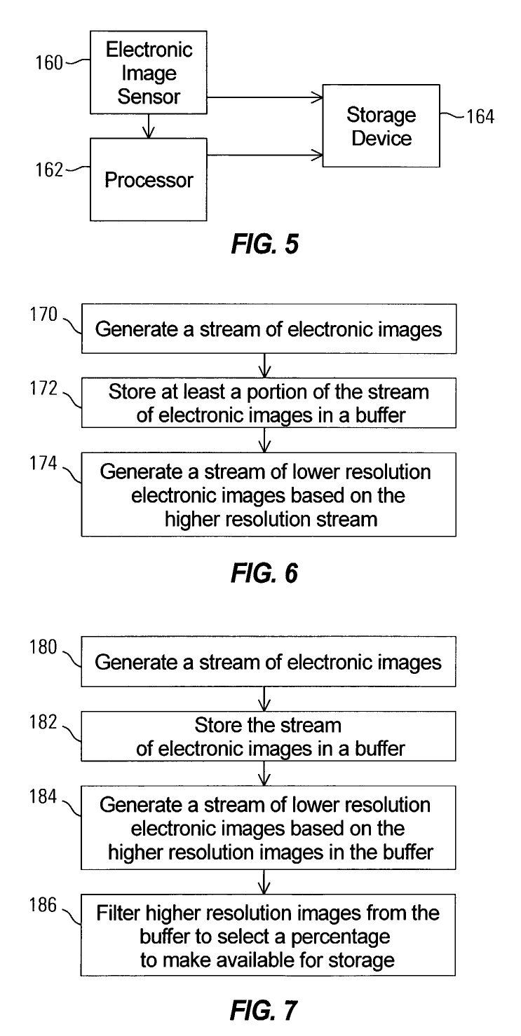

The imaging device 10 includes a lens 12 through which image light passes. The term “image light” as used herein refers to the light reflected from the subject and focused onto the surface of an electronic image sensor (e.g., 100, FIG. 3) inside the imaging device 10. The electronic image sensor of the exemplary embodiment consists of a charge coupled device (CCD), a two dimensional optical detector. A typical CCD comprises a two dimensional array of individual cells or pixels, each of which collects or builds-up an electrical charge in response to exposure to light. Because the quantity of the accumulated electrical charge in any given cell or pixel is related to the intensity and duration of the light exposure, a CCD may be used to detect light and dark spots in an image focused thereon. The CCD of the exemplary embodiment is a high resolution image sensor. For example, the CCD may include millions of pixels, such as a three or four megapixel CCD. Alternatively, the electronic image sensor may consist of any other suitable electronic optical detector, such as a CMOS photodetector array.

The image light may be converted into digital signals in essentially three steps. First, the electronic image sensor converts the image light it receives into a varying electrical current. Second, the varying electrical currents from the sensor elements are converted into analog voltages by an analog amplifier. Finally, the analog voltages are digitized by an analog-to-digital (A/D) converter. The digital image data then may be processed and/or stored as will be described below.

To aid the user in framing the subject, the image data may be displayed on a viewfinder display 14 in a viewfinder 16 which may be adjustable both in position and focus, as is known. The image data may also be displayed on a larger LCD panel 20 that may be extended from the left side 22 of the imaging device 10 on a hinge 24 by pressing an LCD release button 26. The focal length of the imaging device 10 may be adjusted by pressing a zoom control 30 on the top 32 of the imaging device 10.

The high resolution video signal produced by the CCD is downsampled in real-time, as will be described in more detail below, and the resulting low resolution video may be stored on a removable storage device such as a magnetic video tape. The right side 34 of the exemplary imaging device 10 includes a video tape compartment 36 with a window 40 through which the magnetic video tape can be viewed. The storage of the low resolution video may be controlled by a record button 42 on the back 44 of the imaging device 10.

The high resolution video signal may also be temporarily stored in a storage device such as a cyclic memory buffer (e.g., 116, FIG. 3) to be described below. When the user wishes to store recent high resolution video (made up of a series of still frames or images), a high resolution video storage button 46 may be pressed to copy the contents of the buffer to a removable storage device such as a solid state memory 50. The solid state memory 50 may comprise any suitable storage device, such as a compact flash card, smartmedia card, etc. The solid state memory 50 is inserted into a slot 52 in the back 44 of the imaging device 10, and may be ejected by pressing a memory eject button 54 or by simply pulling it out.

Single high resolution still images may also be captured by pressing a single image capture button 56, copying the current image frame from the electronic image sensor or the most recent frame from the buffer to the solid state memory 50.

Other typical components may be included in the imaging device 10 such as playback buttons 64, 66, 70, 72, and 74 in the top 32 of the imaging device 10 for playing back stored low resolution video or high resolution still images or video, and control buttons 76 for configuring the imaging device 10. Other display panels may be provided such as an LCD 80 on the back 82 of the larger LCD panel 20 for displaying any desired information, such as power status or free space remaining on the removable solid state memory 50. Power may be supplied by an AC adapter or a battery 84 connected to a battery clip 86 on the back 44 of the imaging device 10.

The exemplary embodiment of the imaging device 10 includes an active focusing component 90 in the front 92 of the imaging device 10. For example, the active focusing component 90 may include an infrared transmitter which illuminates the subject and an infrared receiver which receives the infrared light reflected from the subject. The active focusing component 90 compares the transmitted infrared with the received in any suitable manner, such as using triangulation, comparing the light intensity, or using light pulses to measure time differences. The active focusing component thus determines the distance from the imaging device 10 to the subject. The imaging device 10 may then focus the lens 12 accordingly.

In operation, the user aims the imaging device 10 at the subject, views the subject on the viewfinder display 14 or larger LCD panel 20, and presses control buttons 42, 46, and 56 to record low resolution video and to store the high resolution buffer contents or the current still image, respectively. Thus, a single device 10 may be used to record both video and still images at the most optimum resolutions for each, simultaneously and simply.

Referring now to the block diagram in FIG. 3, the functions of the imaging device 10 will be described. The electronic image sensor 100 generates a stream of two-dimensional high resolution images. As described above, the electronic image sensor 100 may comprise a CCD with a resolution on the order of three or four megapixels, sufficient for capturing quality still images. (As output devices such as photographic printers improve, a higher resolution CCD may be selected.) A suitably sensitive electronic image sensor 100 is selected so that the desired video frame rate, both in the low resolution and high resolution streams, can be achieved. That is, the electronic image sensor 100 should be able to capture and transmit image frames at a rate up to between about 10 and 30 frames per second (fps).

The electronic image sensor 100 thus produces a high resolution video stream 102 which is fed to a processor 104 for resolution reduction. The processor 104 may comprise any suitable device for reducing the resolution of digital images. In the present exemplary embodiment, the processor 104 reduces the resolution of the digital images in the video stream 102 in real-time. In other words, a low resolution video stream 106 is generated based on the high resolution video stream 102 without buffering the high resolution video stream 102, thus virtually no delay is introduced.

The processor 104 may consist of a microprocessor executing firmware code in the imaging device 10. The processor 104 may be either dedicated to the task of reducing video resolution or shared for other tasks. For example, the processor 104 may also perform tasks such as configuring the imaging device 10, performing image compression, controlling the user interface, focusing including adjusting the lens assembly, processing images, etc, depending upon the speed and power of the processor and the complexity of programming in this multitasking manner.

The processor 104 may alternatively consist of a digital signal processor (DSP), dedicated or otherwise, or an application-specific integrated circuit (ASIC), or any other hardware or software solution suitable for reducing the resolution of the digital images in the high resolution video stream 102 in real-time.

The technique used to reduce the resolution of the high resolution video stream 102 in real-time may depend upon the speed and power of the processor 104. If the speed and power of the processor 104 is limited, the processor 104 may consist of a downsampler that reduces the resolution by pixel dropping. Pixel dropping consists of dropping or deleting pixels from the high resolution images to reduce the overall number of pixels in the corresponding low resolution images. Pixels are dropped in any suitable manner, such as keeping every Nth pixel of every Nth row and discarding the rest. For example, if the electronic image sensor 100 is a three megapixel CCD having a resolution of 2000×1500 pixels, the output frames may be downsampled by a linear factor of 3 in both directions by taking every third pixel in every third row. This would result in an image of 667×500 pixels, sufficient for high quality video at one ninth the memory footprint. (The stored low resolution video may also be compressed using an algorithm such as MPEG compression.)

Alternatively, if the processor 104 has sufficient speed and power, it may downsample the high resolution images in more complex manners to increase image quality. For example, the images may be preprocessed before pixel dropping, such as low-pass filtering the image first to reduce image sharpness, then downsampling, effectively raising image sharpness again as the resolution is reduced.

The downsampling performed by the processor 104 includes resolution reduction, but may also include other reduction techniques such as frame rate reduction, color depth reduction, etc, as desired to generate the low resolution video stream 106.

The low resolution video stream 106 may be stored in the imaging device 10 in a storage device such as a magnetic video tape 110. As described above, storage of the low resolution video may be controlled by a record button 42, starting and stopping as desired.

The high resolution video stream 102 may also be fed into a filter 112 or frame retention selector, which passes only every Nth frame and discards all others, where N is either factory set or user-configurable in the imaging device 10. Thus, rather than capturing every frame of the high resolution video stream 102, the imaging device 10 may capture only a small percentage of them. If the high resolution video stream 102 is being captured for use as high resolution video, N may be set at one to capture every frame. If, on the other hand, the high resolution video stream 102 is being captured as a source of quality high resolution still images, N may be set at a higher number to capture every other or every fifth frame, as desired. If the high resolution video stream 102 is generated at a high frame rate, such as 30 fps, it is probably not necessary to capture 30 still images each second, as most subjects do not change appreciably in a thirtieth of a second.

Furthermore, filtering out more of the image frames from the high resolution video stream 102 either reduces the storage space requirements or increases the amount of time during which still images can be captured. If the high resolution video stream 102 is generated at 10 fps, and only two images per second are captured with the other eight images discarded, only 20% of the storage space is required for the high resolution still images as compared with storing the entire high resolution video stream 102, or the user may capture high resolution still images for five times as long with the same storage space.

The filtered high resolution video stream 114 is temporarily stored in a buffer 116. While the user is imaging or filming a subject with the imaging device 10, the user may decide that the past several seconds of video contained material worth preserving as high resolution still images. The user may then transfer the contents of the buffer 116 into a more permanent storage device by pressing control buttons (e.g., 46 and 56), as will be described in more detail below.

The buffer 116 may comprise a cyclic memory such as a first-in first-out (FIFO) memory. In this type of storage device, the only information accessible is the oldest information, that which was added first. As new information is added to the full buffer 116, the oldest information is automatically shifted out of the buffer 116 and is lost. Thus, a given number of the most recent frames of the filtered high resolution video stream 114 will be kept in the buffer 116, with new frames continually pushing out the oldest automatically.

The buffer 116 may consist of a dedicated FIFO as described above, or may be a random-access memory (RAM) which is either dedicated for use as a buffer or which is shared for other purposes in the imaging device 10. If the buffer 116 comprises a RAM, a memory manager is included to keep track of the location of images in the RAM and to delete the oldest frames in the RAM as new frames are added. In this case, the length of the buffer, that is, the amount of RAM dedicated to temporarily storing image frames, may be either factory set or user configurable.

The contents of the buffer may be transferred 120 to a more permanent storage device such as a solid state memory 122, e.g., a compact flash or smartmedia card. Because the solid state memory 122 of the present exemplary embodiment is removable, the user may carry multiple memories to interchange. The capacity of the solid state memory 122 is balanced between the price and availability of memory versus the storage need of the user to store high resolution still images.

For example, if the electronic image sensor 100 is a three megapixel CCD, and each pixel requires three bytes of memory, a single high resolution still image requires nine megabytes (Mb) of memory. If this is compressed using any desired method, such as jpeg compression, by a factor of ten, each high resolution still image requires 900 kilobytes (Kb). At a frame rate of 30 fps, this requires 900 Kb*30 fps or 27 Mb of memory per second. Thus, a 256 Mb solid state memory 122 could store about 9 or 10 seconds of high resolution video, and much longer if the filter 112 is configured to pass only every 15^{th} frame. If the imaging device 10 is not capable of compressing the images rapidly enough as they pass through the filter 112, buffer 116 and on to the solid state memory 122, but the filter 112 is configured to pass only every 10^{th} high resolution frame, a 256 Mb solid state memory 122 could still store about 9 or 10 seconds of filtered uncompressed high resolution still images.

Controls are included on the imaging device 10 for transferring frames from the buffer 116 and the filtered high resolution video stream 114 to the solid state memory 122. For example, the high resolution video storage button 46 or vid-clip button causes a high resolution storage controller (which may comprise software executing on a processor) to copy high resolution video from the buffer 116 to the solid state memory 122. The imaging device 10 may be designed to transfer the entire contents of the buffer 116. The imaging device 10 may alternatively be configurable with respect to how much of the most recent contents of the buffer 116 is transferred. In the latter case, the user may configure the imaging device 10 to copy less than the entire buffer 116 to the solid state memory 122, depending upon the amount of time over which the user prefers to store still images.

The high resolution video storage button 46 may also cause the imaging device 10 to add the next M seconds of high resolution image frames from the filtered high resolution video stream 114 to the solid state memory 122 after copying the contents of the buffer 116. Thus, the user preserves a segment of high resolution video made both of recent past frames and some future frames. The duration M during which future frames are copied from the filtered high resolution video stream 114 to the solid state memory 122 is user configurable, but may potentially be constrained by the I/O speed of the imaging device 10. Note also that these high resolution still image storage operations are also constrained by the size and free space of the solid state memory 122, thus a copy operation may be started that cannot fully be completed.

Other controls included on the imaging device 10 for storing frames from the filtered high resolution video stream 114 to the solid state memory 122 may include the single image capture button 56 or shutter button. This control causes the imaging device 10 to save a single image frame (or a configurable number of still frames) from the filtered high resolution video stream 114 to the solid state memory 122. These still frames may be copied either directly from the filtered high resolution video stream 114 or from the buffer 116. (A direct path from the filtered high resolution video stream 114 to the solid state memory 122 is not shown in FIG. 3, because the connections are dependent upon the type of buffer 116 and the data bus configuration in the imaging device 10. For example, image frames may be transferred through the buffer 116 if it is a RAM, or around the buffer 116 if it is a FIFO, and the data bus may in any case connect directly to each of the elements shown in FIG. 3.)

Note that FIG. 3 illustrates elements for generating and storing both low resolution video and high resolution video or still images. Additional elements may be included in the paths of FIG. 3 as desired for performing other tasks such as image processing or compression.

Note also that in FIG. 3, the high and low resolution video streams are processed in parallel chronologically, with the low resolution video stream processed by the processor 104 and the high resolution stream processed by the filter 112 and buffer 116. Alternatively, if the hardware performing this processing has sufficient speed and power, the processing of the low and high resolution video streams may be performed serially chronologically. For example, frames from the high resolution video stream 102 may be downsampled and stored, then the high resolution frames may be filtered, buffered, and stored.

Referring now to FIG. 4, an alternative embodiment of the imaging device 10 will be discussed, in which the downsampling is performed on buffered high resolution video. In this embodiment, an electronic image sensor 130 produces a high resolution video stream 132 as described above, which is fed directly into a buffer 134. In this embodiment, the buffer 134 is a RAM so that high resolution video frames may be randomly accessed, or retrieved in any order. The size of the RAM buffer 134 may be selected as desired. The buffered high resolution frames 136 are retrieved by a processor 140 for downsampling, which generates a low resolution video stream 142 for display and storage on a video tape 144.

Because the high resolution video stream 132 is buffered, the processor 140 may or may not perform the downsampling in real-time. For example, the processor 140 may perform the downsampling substantially in real-time by retrieving the most recently added high resolution frames from the buffer 134, or may perform the downsampling in bursts as processing power is available by retrieving consecutive groups of high resolution frames as needed from the buffer 134.

A filter 146 also retrieves buffered high resolution frames 136 from the buffer 134 as described above with respect to FIG. 3, and the filtered high resolution video stream 150 may be stored in a solid state memory 152 as described above.

Note that although the embodiments described above include a solid state memory 152 for high resolution image storage, high resolution images 150 may be stored on any desired type of storage device.

Note also that any delayed downsampling of buffered high resolution video 136 and storage of resulting low resolution video 142 should not effect the video images displayed by the viewfinder 14 or the larger LCD panel 20, as these display images are independently downsampled according to the requirements of the viewfinder display 14 or larger LCD panel 20 in real-time. Delayed downsampling and storage of low resolution video may also be protected from recording problems due to the power being turned off on the imaging device 10 before the buffer is all downsampled and stored or by running out of blank video tape 144. This recording protection may be provided by including a power supply that remains on until the buffered video is downsampled and stored, and by monitoring the available storage space so that full tape conditions can be predicted and reported properly before the buffered video is actually downsampled and stored on the video tape 144.

Referring now to FIG. 4, an alternative embodiment of the imaging device 10 will be discussed, in which downsampling of high resolution video is performed in real-time and current high resolution still frames may be stored. In this embodiment, an electronic image sensor 160 generates a high resolution stream of images which are sent to a processor 162 for resolution reduction. The low resolution video is then stored in a storage device 164 as described above when a control button 42 is pressed. Still frames from the high resolution stream of images may also be stored in the storage device 164 when a single image capture button 56 on the image device 10 is pressed. As described above, other image processing tasks such as compression may be performed on both the low resolution video from the processor 162 and on still frames stored in the storage device 164.

The storage device 164 may be a single large capacity removable memory or multiple media such as the video tape 110 and solid state memory 122 described above.

In summary, the imaging device 10 may capture both high resolution still images and low resolution video simultaneously by generating 170 (FIG. 6) a stream of high resolution electronic images, storing 172 at least a portion of the stream of electronic images in a buffer, and generating 174 a stream of lower resolution electronic images based on the higher resolution stream. The stream of lower resolution electronic images may be generated either on the buffered or unbuffered high resolution image stream.

Alternatively, the imaging device 10 may capture both high resolution still images and low resolution video simultaneously by generating 180 (FIG. 7) a stream of high resolution electronic images, storing 182 the stream of electronic images in a buffer, generating 184 a stream of lower resolution electronic images based on the higher resolution images in the buffer, and filtering the higher resolution images from the buffer to select a percentage of them to make available for more permanent storage.

While illustrative embodiments of the invention have been described in detail herein, it is to be understood that the inventive concepts may be otherwise variously embodied and employed, and that the appended claims are intended to be construed to include such variations, except as limited by the prior art.

What is claimed is:

1. A digital imaging device, comprising:
an electronic image sensor for producing a first signal at a first resolution;
a processor connected to said electronic image sensor output for producing a second signal at a second resolution based on said first signal, wherein said second resolution is lower than said first resolution; and
a memory buffer connected to said electronic image sensor output for temporarily storing said first signal.

2. The digital imaging device of claim 1, further comprising a storage device connected to said memory buffer for storing at least a portion of said first signal.

3. The digital imaging device of claim 2, wherein said storage device is also connected to said processor for storing at least a portion of said second signal.

4. The digital imaging device of claim 1, further comprising a second storage device connected to said processor for storing at least a portion of said second signal.

5. The digital imaging device of claim 2, further comprising a first resolution storage controller connected to said storage device for copying at least a portion of data contained in said memory buffer to said storage device.

6. The digital imaging device of claim 1, further comprising a filter connected between said electronic image sensor and said memory buffer for filtering out a portion of said first signal before it reaches said memory buffer.

7. The digital imaging device of claim 1, wherein said electronic image sensor comprises a charge coupled device.

8. The digital imaging device of claim 1, wherein said processor comprises a downsampling video processor.

9. The digital imaging device of claim 1, wherein said processor produces said second signal in real-time based on said first signal.

10. The digital imaging device of claim 2, wherein said storage device comprises a solid state memory.

11. The digital imaging device of claim 4, wherein said second storage device comprises a magnetic tape.

12. The digital imaging device of claim 1, wherein said processor is connected to said electronic image sensor through said memory buffer so that said second signal is produced from a buffered first signal.

13. A method of capturing images, the method comprising:
generating a stream of electronic images;
storing at least a portion of said stream of electronic images in a buffer; and
generating a second stream of electronic images based on said stream, wherein said second stream has
a lower resolution than said stream.

14. The method of claim 13, wherein said storing at least said portion of said stream of electronic images in said buffer comprises removing an oldest electronic image from said buffer and adding a new electronic image from said stream to said buffer.

15. The method of claim 13, wherein said storing at least said portion of said stream of electronic images in said buffer comprises selecting a fraction of said electronic images from said stream for storage and discarding a remainder of said electronic images from said stream.

16. The method of claim 13, further comprising storing said second stream in a storage device.

17. The method of claim 13, wherein said generating a second stream comprises dropping pixels from images in said stream to produce lower resolution images for said second stream.

18. The method of claim 13, wherein said generating a second stream comprises reading images directly from said stream to produce lower resolution images for said second stream.

19. The method of claim 13, wherein said generating a second stream comprises reading buffered images from said stream through said buffer to produce lower resolution images for said second stream.

20. The method of claim 13, further comprising copying images from said buffer to a removable storage device.

21. The method of claim 20, further comprising copying a number of next images from said stream of electronic images to a removable storage device after said images are copied from said buffer.

22. The method of claim 13, further comprising copying at least one image from said stream of electronic images to a removable storage device.

23. A digital imaging apparatus, comprising:
an electronic image sensor;
a real-time downsampling processor connected to said electronic image sensor having a lower resolution output than said electronic image sensor; and
at least one storage device connected to said lower resolution output and said electronic image sensor.

24. An imaging device, comprising:
means for capturing a series of digital images;
means for temporarily storing a portion of said series of digital images;
means for generating a lower resolution series of digital images from said series of digital images;
means for storing said lower resolution series of digital images; and
means for copying at least part of said portion of said series of digital images to a removable storage device.
